(19) United States
(12) Patent Application Publication
(10) Pub. No.: US 2025/0355499 A1
(43) Pub. Date: Nov. 20, 2025

(54) SYSTEM AND METHOD TO DISPLAY CONTEXTUAL REAL-TIME GAME DATA IN A VIRTUAL REALITY ENVIRONMENT

(71) Applicants: Arthur Daniel Fogle, Aiken, SC (US); Alexander Pierce Fogle, Aiken, SC (US); Tyler Francisco Washburn, Bothell, WA (US)

(72) Inventors: Arthur Daniel Fogle, Aiken, SC (US); Alexander Pierce Fogle, Aiken, SC (US); Tyler Francisco Washburn, Bothell, WA (US)

(21) Appl. No.: 18/664,172

(22) Filed: May 14, 2024

Related U.S. Application Data
(60) Provisional application No. 63/491,266, filed on Mar. 20, 2023.

(51) Int. Cl. G06F 3/01; A63F 13/53; A63F 13/65

(52) U.S. Cl. CPC G06F 3/017; A63F 13/53; A63F 13/65; G06F 3/011; A63F 2300/8082

(57) ABSTRACT

A virtual reality system is disclosed. The system may include a display, a processor and a memory. The display may be configured to render a virtual reality environment for a user wearing the virtual reality system. The memory may store computer-executable instructions, which, when executed by the processor, enables the processor to detect a hand movement of a virtual hand associated with the user in the virtual reality environment. The processor may further determine that the hand movement may be equivalent to a predefined gesture indicating that the user desires to view additional information associated with one or more points of interest (POI) in the virtual reality environment. The processor may additionally cause the display to render the additional information in the virtual reality environment responsive to determining that the hand movement may be equivalent to the predefined gesture.

### CROSS REFERENCE TO RELATED APPLICATIONS AND PRIORITY CLAIM

The present application claims priority to U.S. Provisional Application No. 63/491,266, filed Mar. 20, 2023, the entirety of which is hereby incorporated by reference as if fully set forth herein.

### TECHNICAL FIELD

The present disclosure relates to a system and method to display game data, and more particularly, to a system and method to retrieve and display contextual real-time game data in a virtual reality environment.

### BACKGROUND

In a video game environment, there are many instances where the player desires to view contextual game data, e.g., waypoints, own location in the game, enemy's location, information about one or more points of interest (POI), and/or the like. Further, when the player is playing a game in a virtual reality environment, the player's own arms/hands and/or other body parts act as game “controllers”, and the player may use such controllers to pick or interact with one or more game objects. For example, when the player desires to view the contextual game data, the player may pick a physical “map” in the virtual reality environment by using the controllers, and then unroll the map to view the game data. Such a method of viewing the game data by picking the game object may cause inconvenience to the user, and the game developer may be required to spend additional creation time creating the game object.

Another conventional method to enable the player to view the game data is to overlay the game data on the user interface and utilize some user interface real estate. Such a method results in the loss of valuable user interface real estate, and thus is not desirable. Further, such a method of displaying the game data on the user interface may make the player nauseous, when the player plays the game in the virtual reality environment.

In light of the above, a system and method is required that facilitates the player to conveniently view contextual game data in a virtual reality environment.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example first view of a virtual reality environment in accordance with the present disclosure.

FIG. 3 depicts an example second view of a virtual reality environment in accordance with the present disclosure.

FIG. 4 depicts a flow diagram of an example method to display additional information in a virtual reality environment in accordance with the present disclosure.

### DETAILED DESCRIPTION

### Overview

The present disclosure describes a virtual reality system (“system”) that enables a user to conveniently retrieve and view contextual game data in a virtual reality (VR) environment, when the user may be playing a VR game using the system. The system may include a display, one or more processors, and one or more memory devices. The display may be configured to render the VR environment for the user wearing the system. The memory may store computer-executable instructions, which, when executed by the processor, enables the processor to detect a hand movement of a virtual hand associated with the user in the VR environment. The virtual hand may be rendered on the display when the user moves the virtual hand. The processor may further determine that the hand movement may be equivalent to a predefined gesture indicating that the user desires to view additional information associated with one or more points of interest (POI) in the VR environment. Responsive to determining that the hand movement is equivalent to the predefined gesture, the processor may cause the display to render the additional information in the VR environment.

In some aspects, the predefined gesture may include the virtual hand being raised in proximity to a browline or forehead of the user. In certain embodiments, the memory may include an eye shielding detector module configured to detect that the virtual hand may be raised in proximity to the browline or forehead of the user. The processor may be configured to detect that the hand movement may be equivalent to the predefined gesture by executing instructions stored in the eye shielding detector module.

In further aspects, the processor may be configured to execute the instructions stored in the eye shielding detector module to detect that the virtual hand may be moved away from the browline or forehead of the user, and cause the display to stop rendering the additional information in the VR environment responsive to detecting that the virtual hand may be moved away from the browline or forehead of the user.

In additional aspects, the memory may include a POI marker module configured to store information associated with one or more markers associated with one or more POIs. The processor may be further configured to cause the display to render the additional information in the VR environment based on the information associated with the markers. In an exemplary aspect, the information associated with the markers may include information associated with a visual appearance of the markers.

The processor may be further configured to execute instructions stored in the POI marker module to detect a virtual distance of a user's real-time virtual location from one or more POIs in the VR environment, and cause the display to scale the rendering of the additional information in the VR environment based on the virtual distance. In some aspects, the additional information rendered in the VR environment may further include the detected virtual distance. In certain aspects, the additional information rendered in the VR environment may further include an icon and/or a name associated with the markers.

In further aspects, the processor may be configured to execute the instructions stored in the POI marker module to detect a field of view (FOV) or a camera angle of the user in the VR environment, and cause the display to render the additional information in the VR environment based on the FOV or the camera angle.

In additional aspects, the memory may include a POI supplier module configured to store and supply at least one of a POI class, contextual game data and non-player character-specific data to the processor. In some aspects, the additional information rendered in the VR environment may include the contextual game data and non-player character-specific data. In an exemplary aspect, the contextual game data may include at least one of one or more waypoints, compass points, user's real-time virtual location, enemy's virtual location in the VR environment, quest objectives or locations, icons associated with towns or animals, and/or the like.

In further aspects, the memory may include a POI display manager module configured to instantiate one or more available markers in the VR environment. The processor may be further configured to execute instructions stored in the POI display manager module to determine the available markers within a game scene being viewed by the user in the VR environment based on information supplied by the POI supplier module.

In alternative or additional aspects, the predefined gesture may include at least one of the user tapping a finger of user's one virtual hand to a palm of user's second virtual hand, or the user moving or waving the virtual hand from left to right or right to left in the VR environment. In further aspects, the additional information may be rendered in proximity to the POI in the VR environment.

In further embodiments of the present disclosure, a method to display additional information in a VR environment is disclosed. The method may include detecting, by a processor, a hand movement of a virtual hand associated with a user in the VR environment. The virtual hand may be rendered on a display when the user moves the virtual hand, and the display may be configured to render the VR environment for the user wearing a virtual reality system.

The method may further include determining, by the processor, that the hand movement may be equivalent to a predefined gesture indicating that the user desires to view the additional information associated with one or more points of interest (POI) in the VR environment. The method may additionally include causing, by the processor, the display to render the additional information in the VR environment responsive to determining that the hand movement may be equivalent to the predefined gesture.

In yet another embodiment of the present disclosure, a non-transitory computer-readable storage medium in a distributed computing system is disclosed. The non-transitory computer-readable storage medium has instructions stored thereupon which, when executed by a processor, cause the processor to detect a hand movement of a virtual hand associated with a user in the VR environment. The virtual hand may be rendered on a display when the user moves the virtual hand, and the display may be configured to render the VR environment for the user wearing a virtual reality system.

The processor may further determine that the hand movement may be equivalent to a predefined gesture indicating that the user desires to view the additional information associated with one or more points of interest (POI) in the VR environment. The processor may additionally cause the display to render the additional information in the VR environment responsive to determining that the hand movement may be equivalent to the predefined gesture.

The present disclosure discloses a system and method that is implemented by a collection of computer-executable instructions that create and manage a virtual compass and a point of interest (POI) supplier and provider, made specifically for virtual reality (VR) games. The system and method enable a game player or a user to find the way across a massive game world without having to rely on retrieving or using an item (e.g., a game object) from the user's possession. Further, the system and method do not take up valuable user interface real estate in the VR environment. Game developers can customize the look of one or more markers associated with one or more POIs, and how the markers are activated, giving the player/user a real-time, immersive experience and an easy access to relevant game data when needed.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

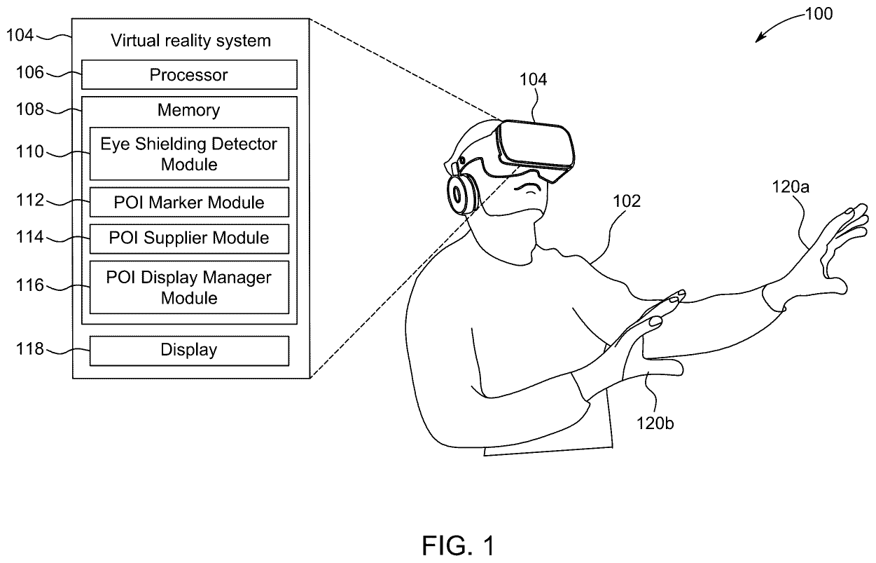

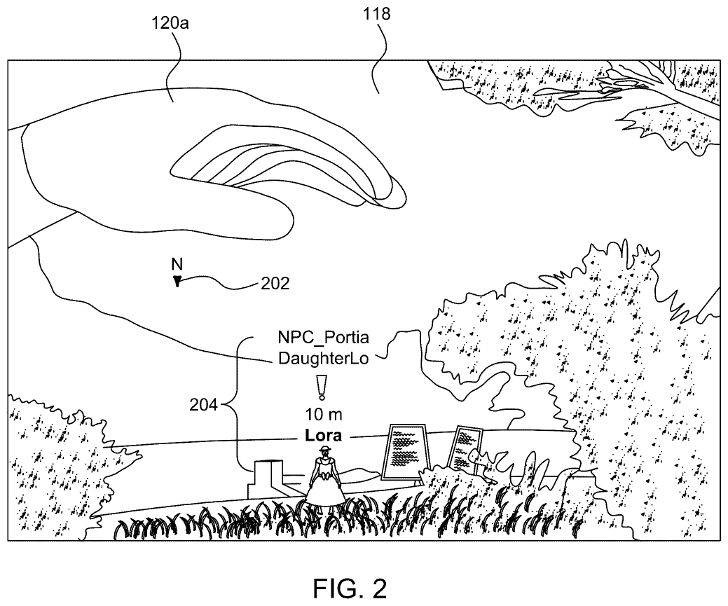

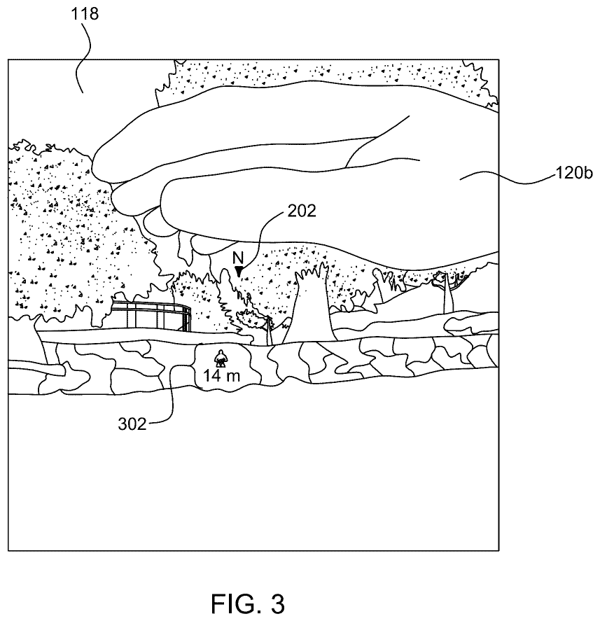

FIG. 1 depicts an example environment 100 in which techniques and structures for providing the systems and methods disclosed herein may be implemented. FIG. 1 will be described with continued references to FIGS. 2 and 3. The environment 100 may include a user 102 operating a virtual reality system 104 (or system 104). In some aspects, the system 104 may be a head mounted display device that may be configured to render a virtual reality (VR) game or a virtual reality environment for the user 102. The user 102 may be wearing the system 104 on the user's head/face (as shown in FIG. 1), and may control one or more VR game features by moving the user's body parts, e.g., arms, hands, feet, head, and/or the like.

The system 104 may enable the user 102 to conveniently retrieve and view contextual game data or information related to game play in the virtual reality environment rendered on the system 104, without having to interact with any game object. Further, the system 104 does not use valuable user interface real estate to display the contextual game data, thereby further enhancing the user's gaming experience.

The system 104 may include a plurality of components/units including, but not limited to, a processor 106, a memory 108, an eye shielding detector module 110, a point of interest (POI) marker module 112, a POI supplier module 114, a POI display manager module 116, a display 118, and/or the like, which may be communicatively coupled with each other.

The display 118 may be configured to render a virtual reality environment associated with the VR game for the user 102 who may be wearing the system 104. Example views of the virtual reality environment rendered on the display 118 are shown in FIGS. 2 and 3.

The memory 108 may store programs in code and/or store data for performing various operations in accordance with the present disclosure. Specifically, the processor 106 may be configured and/or programmed to execute computer-executable instructions stored in the memory 108 for performing various functions in accordance with the disclosure. Consequently, the memory 108 may be used for storing code and/or data code and/or data for performing operations in accordance with the present disclosure.

The memory 108 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 108 may be one example of a non-transitory computer-readable medium or memory and may be used to store programs in code and/or to store data for performing various operations in accordance with the disclosure. The instructions in the memory 108 may include one or more separate programs, each of which may include an ordered listing of computer-executable instructions for implementing logical functions.

In some aspects, the eye shielding detector module 110, the POI marker module 112, the POI supplier module 114, and the POI display manager module 116 may be part of the memory 108 or may be stored in the memory 108. In other aspects, one or more of these modules may be outside the memory 108. The eye shielding detector module 110, the POI marker module 112, the POI supplier module 114, and the POI display manager module 116, as described herein, may be stored in the form of computer-executable instructions, and the processor 106 may be configured and/or programmed to execute the stored computer-executable instructions for performing functions in accordance with the present disclosure. The functions of these modules are described later in the description below.

As described above, the system 104 may enable the user 102 to conveniently retrieve and view contextual game data or information related to game play on the virtual reality environment rendered on the display 118. During operation, when the user 102 may be playing the VR game and desires to view the contextual game data at any given time, the user 102 may perform a predefined action or gesture by using a user's left hand 120a, a user's right hand 120b, a user's right or left foot (not shown), and/or the like.

Responsive to the user performing the predefined gesture, e.g., a hand movement, the processor 106 may detect the hand movement. Specifically, the system 104 may replicate and render the user's physical hand movement in the virtual reality environment that may be getting displayed on the display 118, and the processor 106 may detect the hand movement of the user's virtual hand in the virtual reality environment. The processor 106 may then compare the detected hand movement with a predefined gesture indicating that the user 102 desires to view additional information or contextual game data associated with one or more points of interest (POI) in the virtual reality environment rendered on the display 118.

In an exemplary aspect, the predefined gesture may be the virtual hand being raised in proximity to a browline or forehead of the user 102, mimicking a hand movement that the user 102 may make when the user 102 may be shielding user's eyes from sun and trying to get a better view/look. An example view of the virtual left hand 120a being raised in proximity to the browline or forehead of the user 102 is shown in FIG. 2, and an example view of the virtual right hand 120b being raised in proximity to the browline or forehead of the user 102 is shown in FIG. 3.

Responsive to determining that the hand movement may be equivalent to the predefined gesture, the processor 106 may cause the display 118 to render the additional information or contextual game data in the virtual reality environment. For example, as shown in FIG. 2, responsive to the user 102 raising the left hand 120a in proximity to the browline or forehead of the user 102, the processor 106 may cause the display 118 to render a compass 202 and/or name/label, an icon, a virtual distance from the user 102 (collectively referred to as additional information 204), and/or the like associated with a POI in the virtual reality environment. Similarly, as shown in FIG. 3, responsive to the user 102 raising the right hand 120b in proximity to the browline or forehead of the user 102, the processor 106 may cause the display 118 to render the compass 202 and/or a quest marker, the virtual distance from the user 102 (collectively referred to as additional information 302), and/or the like associated with a POI in the virtual reality environment. In this manner, the additional information or contextual game data is displayed in the virtual reality environment only when the user 102 desires to view the data and not otherwise, thereby not unnecessarily obstructing user's view and/or consuming user interface real estate. Further, the user 102 is not required to pick any game object (e.g., a map) to view the additional information or contextual game data, and may simply view the data by performing the predefined gesture, thereby considerably enhancing the user's gaming experience. In some aspects, the additional information may be rendered in proximity to the POI in the virtual reality environment. In some aspects, a compass is rendered in game above the users hand that reorients as you look around.

In some aspects, the processor 106 may execute the instructions stored in the eye shielding detector module 110, the POI marker module 112, the POI supplier module 114, and the POI display manager module 116 to perform the steps described above. These modules are described below one by one.

The eye shielding detector module 110 may be configured to detect that the virtual hand may be raised in proximity to the browline or forehead of the user 102, and the processor 106 may be configured to detect that the hand movement may be equivalent to the predefined gesture by executing the instructions stored in the eye shielding detector module 110. The processor 106 may be further configured to execute the instructions stored in the eye shielding detector module 110 to detect that the virtual hand may be moved away from the browline or forehead of the user 102, e.g., when the user 102 lowers the left hand 120a or the right hand 120b away from the “eye shielding” position. Responsive to detecting that the virtual hand may be moved away from the browline or forehead of the user 102, the processor 106 may cause the display 118 to stop rendering the additional information in the virtual reality environment.

In some aspects, the eye shielding detector module 110 may be configured to “attach” the location in front of the player's head bone in the avatar hierarchy, which catches the “shielding of eyes” gesture or enables the processor 106 to determine that the user's hand movement may be equivalent to the predefined gesture, thereby initiating the process of displaying the additional information or contextual game data on the display 118.

The POI marker module 112 may be configured to store information associated with one or more markers associated with one or more POIs that be displayed in the virtual reality environment. For example, the POI marker module 112 may store image, float and text variables that manages what each marker may look like and when the marker may be seen by the player/user 102. In some aspects, in the Awake method of the virtual game, default values may be applied and the GameObject may be set to inactive, so that the marker is ready when the user 102 activates it. This can be attached to a prefab that may be used by the processor 106 to display the marker.

In some aspects, the information associated with the markers may include information associated with a visual appearance of each marker, and the processor 106 may cause the display 118 to render the additional information or contextual gate data in the virtual reality environment based on the information associated with the markers. The processor 106 may be further configured to execute instructions stored in the POI marker module 112 to detect a virtual distance of a user's real-time virtual location from a POI/marker in the virtual reality environment. Responsive to detecting the virtual distance, the processor 106 may cause the display 118 to scale the rendering of the additional information or contextual game data in the virtual reality environment based on the virtual distance. The processor 106 may further manage the scale of the rendering of the additional information, so that the rendering may fade in and out as the player/user 102 gets nearer or further from the marker's location. In some aspects, the additional information or contextual game data that is rendered in the virtual reality environment may further include the virtual distance of the user's real-time virtual location from the marker, as shown in the additional information 204, 302 of FIGS. 2 and 3. The additional information may also include an icon, a name, and/or the like associated with the marker(s), as shown in the additional information 204, 302 and as described above.

The processor 106 may be further configured to execute the instructions stored in the POI marker module 112 detect a field of view (FOV) or a camera angle of the user 102 in the virtual reality environment, and cause the display 118 to render the additional information or the contextual game data in the virtual reality environment based on the FOV or the camera angle. Specifically, the processor 106 may cause the marker/additional information to face the direction of the player's camera.

The POI supplier module 114 may be configured to store and supply information associated with a POI class, contextual game data and/or non-player character-specific data to the processor 106. In some aspects, the additional information that is rendered in the virtual reality environment may include the contextual game data and non-player character-specific data. Examples of the contextual game data may include, but are not limited to, one or more waypoints, compass points, user's real-time virtual location, enemy's virtual location in the virtual reality environment, quest objectives or locations, icons associated with towns or animals, and/or the like.

The POI display manager module 116 may be configured to instantiate one or more available markers in the virtual reality environment. The processor 106 may be configured to execute the instructions stored in the POI display manager module 116 to determine the available markers within a game scene being viewed by the user 102 in the virtual reality environment based on the information supplied by the POI supplier module 114, and then cause the display 118 to render the additional information or the contextual game data associated with the available markers.

In some aspects, the POI display manager module 116 may store a POIMarker prefab that can be used to instantiate markers in the game world. The POI display manager module 116 may also create a dictionary that can take the available markers to the player/user 102 at any given time. These may be supplied by the POI supplier module 114 within the game world so that different scenes may supply different sets of POIs. The main camera may be later passed to each POIMarker to determine, for example, its distance from the camera, which can also be the player's or user's location. In some aspects, the rendering of the additional information/marker is invoked at every update when flagged to do so by, for example, a boolean. This ensures that the user 102 always sees what is needed to be seen, but only when needed. The system 104 may also destroy the POIs no longer needed, and create new ones if they do not already exist.

In some aspects, the system 104 may provide POI features described above so that the user 102 may see a toggleable image of the game world with identifiers of meaningful and relevant game content. By using the features described above, the user 102 may locate the game content in relation to the user's current position in the game world, thus enhancing the user's gaming experience. In additional or alternative aspects, an actual ‘map’ that can be unrolled and put away in the user's bag may also be provided by the system 104.

A person ordinarily skilled in the art may appreciate from the description above that the system 104 enables the user 102 to retrieve information in the virtual reality environment when the user 102 raises the user's physical or virtual hand to the user's browline (or forehead). When the user 102 performs such a gesture, information including, but not limited to, information regarding the player or person's current location, location of other players or persons, towns, quest objectives, animals, enemies, friendly non-playable characters, events and other game-relevant data appear on the ‘horizon’ in view of the user 102 (as shown in FIGS. 2 and 3), and can rotate in relation to the user's position to allow the user 102 a full view of all data in all directions.

When the user 102 raises the user's physical or virtual hand to the user's browline or higher, text and icons may appear in the user's vision, displaying a compass direction, as well as icons for towns, non-playable characters, enemies, trackable animals, and quest locations, as well as other contextual game relevant data points, together with displaying the distance to those points from the player's current position in the game. The system 104 satisfies the need to retrieve this game data by the user 102 in a novel way in the virtual reality environment much more quickly than using an in-game item to call up this data while hiding it from view. The system 104 provides a way to de-clutter the screen (which is paramount for immersion in a virtual reality setting) of an open world game where the player/user 102 is the character.

In some aspects, certain icons may only be seen in the virtual reality environment when certain criteria may be met. Examples of such criteria include, but are not limited to, the quest the user 102 is currently involved with, unlocking an ability that allows tracking, forming a group and seeing friendly players, seeing other players when joined in a party, or events that would point players to a location in the game world, and/or the like.

As described above, in some aspects, the user 102 may use the user's virtual hand/arm/controller in-game to shield the user's eyes to view additional game information and data. In other aspects, the user 102 may also use, by way of example, but not limited to, other items such as binoculars, goggles, a helmet, glasses, a mask, or other items that can be worn on the body of the user 102 to view additional game information.

By way of additional examples, the user 102 may (in addition to or in lieu of raising the user's physical or virtual hand) tap a finger from the user's right hand to the palm of the user's left hand (or vice versa), by one or two taps (once for information screen data “A” and twice for information screen data “B”), or the user 102 may swipe the user's physical or virtual hand or hands across the view in front of, to the side of, behind, or in any other motion or gesture and depending on the type of motion get different sets of information presented in the virtual reality environment on the display 118. Stated another way, the predefined gesture described above may additionally or alternatively include the user 102 tapping a finger of user's one virtual hand to a palm of user's second virtual hand, the user 102 moving or waving the user's virtual hand from left to right or right to left in the virtual reality environment, and/or the like. In additional aspects, the user 102 may tap or move other parts of the user's physical or virtual body (for example, the user's foot) to access information as well.

Example scripts associated with the plurality of system functions (as described above) are provided below. The scripts provided below are just for illustrative purpose, and should not be construed as limiting.

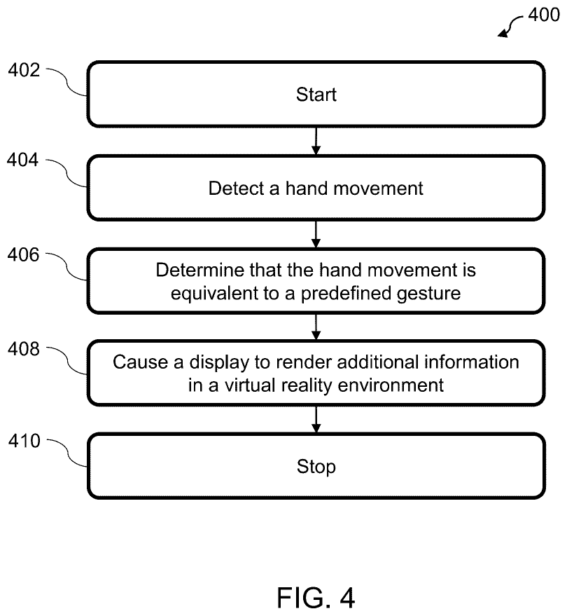

FIG. 4 depicts a flow diagram of an example method 400 to display additional information in a virtual reality environment in accordance with the present disclosure. FIG. 4 may be described with continued reference to prior figures, including FIGS. 1-3. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include detecting, by the processor 106, the hand movement of the virtual hand associated with the user 102 in the virtual reality environment. At step 406, the method 400 may include determining, by the processor 106, that the hand movement is equivalent to a predefined gesture indicating that the user 102 desires to view the additional information associated with one or more POIs in the virtual reality environment. At step 408, the method 400 may include causing, by the processor 106, the display 118 to render the additional information in the virtual reality environment, responsive to determining that the hand movement is equivalent to the predefined gesture.

At step 410, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A virtual reality system comprising:
a display configured to render a virtual reality environment for a user wearing the virtual reality system;
a processor; and
a memory storing computer-executable instructions, the processor programmed to execute instructions to:
detect a hand movement of a virtual hand associated with the user in the virtual reality environment, wherein the virtual hand is rendered on the display when the user moves the virtual hand;
determine that the hand movement is equivalent to a predefined gesture indicating that the user desires to view additional information associated with one or more points of interest (POI) in the virtual reality environment; and
cause the display to render the additional information in the virtual reality environment responsive to determining that the hand movement is equivalent to the predefined gesture.

2. The virtual reality system of claim 1, wherein the predefined gesture comprises the virtual hand being raised in proximity to a browline or forehead of the user.

3. The virtual reality system of claim 2, wherein the memory comprises an eye shielding detector module configured to detect that the virtual hand is raised in proximity to the browline or forehead of the user, and wherein the processor is configured to detect that the hand movement is equivalent to the predefined gesture by executing instructions stored in the eye shielding detector module.

4. The virtual reality system of claim 3, wherein the processor is further configured to execute the instructions stored in the eye shielding detector module to detect that the virtual hand is moved away from the browline or forehead of the user, and wherein the processor causes the display to stop rendering the additional information in the virtual reality environment responsive to detecting that the virtual hand is moved away from the browline or forehead of the user.

5. The virtual reality system of claim 1, wherein the memory further comprises a POI marker module configured to store information associated with one or more markers associated with the one or more POI, and wherein the processor is further configured to cause the display to render the additional information in the virtual reality environment based on the information associated with the one or more markers.

6. The virtual reality system of claim 5, wherein the information associated with the one or more markers comprises information associated with a visual appearance of the one or more markers.

7. The virtual reality system of claim 5, wherein the processor is further configured to execute instructions stored in the POI marker module to detect a virtual distance of a user's real-time virtual location from the one or more POIs in the virtual reality environment, wherein the processor causes the display to scale the rendering of the additional information in the virtual reality environment based on the virtual distance, and wherein the additional information further comprises the virtual distance.

8. The virtual reality system of claim 7, wherein the processor is further configured to execute the instructions stored in the POI marker module to detect a field of view (FOV) or a camera angle of the user in the virtual reality environment, and cause the display to render the additional information in the virtual reality environment based on the FOV or the camera angle.

9. The virtual reality system of claim 5, wherein the additional information further comprises an icon and a name associated with the one or more markers.

10. The virtual reality system of claim 1, wherein the memory further comprises a POI supplier module configured to store and supply at least one of a POI class, contextual game data and non-player character-specific data to the processor, and wherein the additional information comprises the contextual game data and non-player character-specific data.

11. The virtual reality system of claim 10, wherein the contextual game data comprises at least one of one or more waypoints, compass points, user's real-time virtual location, enemy's virtual location in the virtual reality environment, quest objectives or locations, and icons associated with towns or animals.

12. The virtual reality system of claim 10, wherein the memory further comprises a POI display manager module configured to instantiate one or more available markers in the virtual reality environment, and wherein the processor is configured to execute instructions stored in the POI display manager module to determine the one or more available markers within a game scene being viewed by the user in the virtual reality environment based on information supplied by the POI supplier module.

13. The virtual reality system of claim 1, wherein the predefined gesture comprises at least one of the user tapping a finger of user's one virtual hand to a palm of user's second virtual hand, or the user moving or waving the virtual hand from left to right or right to left in the virtual reality environment.

14. The virtual reality system of claim 1, wherein the additional information is rendered in proximity to the POI in the virtual reality environment.

15. A method to display additional information in a virtual reality environment, the method comprising:
detecting, by a processor, a hand movement of a virtual hand associated with a user in the virtual reality environment, wherein the virtual hand is rendered on a display when the user moves the virtual hand, and wherein the display is configured to render the virtual reality environment for the user wearing a virtual reality system;
determining, by the processor, that the hand movement is equivalent to a predefined gesture indicating that the user desires to view the additional information associated with one or more points of interest (POI) in the virtual reality environment; and
causing, by the processor, the display to render the additional information in the virtual reality environment responsive to determining that the hand movement is equivalent to the predefined gesture.

16. The method of claim 15, wherein the predefined gesture comprises the virtual hand being raised in proximity to a browline or forehead of the user.

17. The method of claim 16 further comprising:
detecting that the virtual hand is moved away from the browline or forehead of the user; and
causing the display to stop rendering the additional information in the virtual reality environment responsive to detecting that the virtual hand is moved away from the browline or forehead of the user.

18. The method of claim 15, wherein the additional information comprises contextual game data and non-player character-specific data, and wherein the contextual game data comprises at least one of one or more waypoints, compass points, user's real-time virtual location, enemy's virtual location in the virtual reality environment, quest objectives or locations, and icons associated with towns or animals.

19. The method of claim 15, wherein the predefined gesture comprises at least one of the user tapping a finger of user's one virtual hand to a palm of user's second virtual hand, the user moving or waving the virtual hand from left to right or right to left in the virtual reality environment.

20. A non-transitory computer-readable storage medium in a distributed computing system, the non-transitory computer-readable storage medium having instructions stored thereupon which, when executed by a processor, cause the processor to:
detect a hand movement of a virtual hand associated with a user in a virtual reality environment, wherein the virtual hand is rendered on a display when the user moves the virtual hand, and wherein the display is configured to render the virtual reality environment for the user wearing a virtual reality system;
determine that the hand movement is equivalent to a predefined gesture indicating that the user desires to view the additional information associated with one or more points of interest (POI) in the virtual reality environment; and
cause the display to render the additional information in the virtual reality environment responsive to determining that the hand movement is equivalent to the predefined gesture.
